(19) United States
(12) Patent Application Publication
(10) Pub. No.: US 2007/0193854 A1
(43) Pub. Date: Aug. 23, 2007

(54) GATELESS MODULAR CONVEYOR DISTRIBUTION SYSTEM

(75) Inventors: Mark Eaton, West Linn, OR (US); Larry Martin, Lake Oswego, OR (US); Dennis White, Kalama, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: FMC TECHNOLOGIES, INC., Houston, TX (US)

(21) Appl. No.: 11/670,373

(22) Filed: Feb. 1, 2007

Related U.S. Application Data
(63) Continuation of application No. 11/592,722, filed on Nov. 3, 2006.
(60) Provisional application No. 60/733,565, filed on Nov. 4, 2005.

(51) Int. Cl. B65G 47/10

(52) U.S. Cl. 198/348

(57) ABSTRACT

A conveyor distribution system 100 includes a first conveyor module 103 for receiving work product to be distributed and having an elongated pan 105. The outlet end of the first conveyor pan 105 being in registry with and at an elevation above the proximal end of a conveyor pan 107 of a second conveyor module 109 to define a discharge gap 111 between the two conveyor pans. The second conveyor 109 operable to move the work product both downstream and upstream along the second conveyor pan 107, thereby to discharge work product from either the distal or proximal ends of the second conveyor pan. A third or even additional conveyor modules may be employed for further distribution of the work product.

### CROSS-REFERENCE TO RELATED APPLICATION

This application is a continuation of U.S. application Ser. No. 11/592,722, filed Nov. 3, 2006, which claims the benefit of U.S. Provisional Application No. 60/733,565, filed Nov. 4, 2005; said applications are considered as being part of the disclosure of this application and are hereby incorporated by reference herein.

### FIELD OF THE INVENTION

This invention relates to modular vibratory and differential motion conveyor systems that are used to distribute bulk materials to a series of packaging machines. In particular the invention relates to an improved distribution system utilizing several differential motion, bi-directional feed conveyors, arranged such to eliminate the need for electro-pneumatic operated gates, and/or to eliminate the discharge feeders at the discharge points to the packaging machines.

### BACKGROUND OF THE INVENTION

Snack food manufacturers and the like use modular weighing and packaging systems at the output of the cooking process to weigh and to package their product into bags for customer consumption. Such systems generally are based about a series of at least two or more combined weighing and packaging machines arranged linearly side by side at a specific machine center-to-center spacing. An advantage of such a modular system is that it is expandable, up to the maximum product capacity that can be handled by the size of the first conveyor in the distribution system, by adding an additional packaging machine and supply conveyor, gate, and transverse feeder as discussed in the following description.

The modular product distribution system of the prior art, supplying product to each combined weighing and packaging machine in the system, usually consists of a storage hopper to receive product from the cooking process, and a first conveyor to move product from the outlet of the storage hopper to a discharge point above and to the rear of the center of the inlet cone of the first packaging machine. An electro-pneumatic operated gate is located near the discharge end of the first conveyor, and a transverse mounted vibratory feeder is provided to convey material from the discharge gate to the center of the inlet cone of the first packaging machine.

The combined weighing and packaging machine also includes a second conveyor to move product from the discharge end of the first conveyor to a discharge point above and to the rear of the center of the inlet cone of the second packaging machine. An electro-pneumatic operated gate is positioned near the discharge end of the second conveyor, and a transverse mounted vibratory feeder is used to convey material from the discharge gate to the center of the inlet cone of the second packaging machine.

The combined weighing and packaging machine may include a third conveyor to move product from the discharge of the second conveyor to a discharge point above and to the rear of the center of the inlet cone of a third packaging machine. An electro-pneumatic operated gate is positioned near the discharge end of the third conveyor, and a transverse mounted vibratory feeder is used to convey material from the discharge gate to the center of the inlet cone of the third packaging machine.

This modular construction can include additional conveyors, packaging machinery, and related components.

As product is fed along the conveyors, a demand signal from a high/low level sensor in a transverse feeder, or from the packaging machine, operates the discharge gate to transfer the product to the transverse feeder. A “high level” signal from the sensor closes the gate. If the product demand is such that the level of product on all the transverse feeders is high, their high/low level sensors cause the control system to temporarily shut down the modular conveyors. A transition funnel section might be required in some applications between the discharge gates and transverse feeder to guide product to the feeder trough to prevent spillage. The transverse feeder is used to control the flow of material onto the cone of the packaging machine and to provide a storage buffer to smooth any level inconsistencies in the input feed. The demand sensors of the packaging machine, in turn, control the operation of the transverse feeder.

Product from the cooking process may be transported to the storage hopper of the distribution system via vibratory conveyors, belt conveyors or, in some instances, by hand in some form of bulk container, which is dumped into the supply hopper. A frame work is used to mount the hoppers, conveyors, feeders, transition members, controls and other equipment that may be required. Each packaging machine utilizes a bag-forming apparatus that forms a bag from plastic or foil film. The weighed product is “dumped” into the bag, and then the bag is sealed and discharged. Other operations such as date stamping, etc., might also be performed at the bagging operation.

All prior art systems known to the inventors utilize some form of an electro-pneumatic operated gate to discharge product to the appropriate packaging machine on demand from the machine's control system. Even the best-designed gates are a major source of maintenance problems associated with modular distribution systems. During operation the gates may trap and crush product material. The crushed dust may accumulate in the guide mechanism for the gate and build up, causing jamming of the gate, leading to process malfunction and possible damage to the gate mechanisms. The dust and crushed product is also unsanitary if allowed to accumulate, therefore the operators often spend considerable time in cleaning the equipment in the gate areas to make sure that the sanitary standards are met. In some situations, the gate components are fairly easily removable to facilitate the cleaning process. The pneumatically operated gate requires a clean air supply along with all of its solenoid valves, electric wiring, air hose plumbing, air regulators, filters, pressure gauges, lubricators, piping from the compressor room, compressor, etc. All told, the electro-pneumatic gate is a critical component of the modular distribution system and is an expensive component to build, install, and maintain with an appreciable operating cost.

Typical modular systems use either vibratory conveyors or differential motion conveyors as the distribution conveyor equipment. Differential motion conveyors employ conveying forces having substantially only horizontal components, unlike vibratory conveyors in which the conveying forces have both horizontal and vertical components. Since no significant vertical force components exist, it is generally perceived that differential motion conveyors handle fragile material such as snack foods in a gentler manner and therefore have less product breakage and build-up of food particles or flavoring material on the conveying surface than vibratory conveyors do. Another characteristic of the differential motion conveyor is that they can usually be made to reverse their feed direction. A caveat relative to the differential motion conveyor is that it cannot feed product against any backpressure in the system, therefore product will not build up in the conveyor trough or pan, but will in fact stop flowing if the product encounters a blockage in the feed path.

### EXAMPLE OF PRIOR ART

FIG. 1 is a side elevational view, in schematic, of a typical prior art modular distribution system for a series of combined weighing/packaging machines. A system utilizing three packaging machines is illustrated. The outlet of a supply hopper 1 is positioned over the inlet of a vibratory or differential motion conveyor module 3. A slide gate 2 is mounted to the bottom of the discharge end of the conveyor module 3. The discharge end of the conveyor module 3 is positioned over the inlet end of a second conveyor module 4. The opening of the slide gate 2 is positioned over a transition funnel section 12 to guide product into the trough of a transverse feeder 6. The transverse feeder 6 discharges product onto a cone-shaped inlet receiver 30 of a combination weighing/packaging machine 9, from where the product is transferred into the weigh buckets 15 of the machine 9.

The second conveyor module 4 has a slide gate 16 mounted at the bottom of its discharge end, the opening of which is positioned over the transition funnel section 13 to guide product into the trough of a transverse feeder 7. The transverse feeder 7 discharges product onto a cone-shaped inlet receiver 52 of a combination weighing/packaging machine 10, from where the product is transferred into weigh buckets 24 of the machine 10. The discharge end of the conveyor module 4 is positioned over the inlet end of a third conveyor module 5. The discharge end of the third conveyor module 5 is in turn positioned over a transition funnel section 14 to guide product into the trough of a transverse feeder 8. The transverse feeder 8 discharges product onto a cone-shaped inlet receiver 53 of a combined weighing/packaging machine 11, from where the product is transferred into the weigh buckets 26 of the machine 11.

FIG. 2 is a top view of the prior art modular conveyor distribution system of FIG. 1, illustrating the positional relationship of the conveyor system to the combined weighing and packaging machines. Also, FIGS. 3 and 4 are fragmentary side elevational and bottom views of a slide discharge gate. The supply hopper 1 is shown positioned over the inlet of the conveyor module 3. The discharge end of the conveyor module 3 is positioned over the inlet end of a second conveyor module 4. The discharge end of the conveyor module 4 is positioned over the inlet end of a third conveyor module 5. A slide gate 2 is mounted to the bottom of the discharge end of the conveyor module 3, see FIGS. 3 and 4. The opening 40 of the slide gate 2 is positioned over a transition funnel section 12 to guide product into the trough of the transverse feeder 6. The transverse feeder 6 discharges product onto the cone-shaped inlet receiver 30 of the combined weighing/packaging machine 9, from where the product is transferred into the weigh buckets 15 of the machine 9.

The second conveyor module 4 has a slide gate 16 mounted to the bottom of its discharge end, the opening 54 of which is positioned over the transition funnel section 13 to guide product into the trough of the transverse feeder 7. The transverse feeder 7 discharges product onto the cone-shaped inlet receiver 52 of the combined weighing/packaging machine 10, from where the product is transferred into the weigh buckets 24 of the machine 10.

The discharge end of the third conveyor module 5 is positioned over the transition funnel section 14 to guide product into the trough of the transverse feeder 8. The transverse feeder 8 discharges product onto the cone-shaped inlet receiver 53 of the combined weighing/packaging machine 11, from where the product is transferred into the weigh buckets 26 of the machine 11.

FIG. 3 is a fragmentary side elevational view of the pneumatic operated slide discharge gate 2 of FIG. 1, mounted on the bottom of and near the discharge end of conveyor module 3. A mounting bracket 23, fastened to the bottom of the trough conveyor 3, secures one end of a pneumatically operated cylinder 22 and its cylinder rod 17. The other end of the pneumatically operated cylinder 22 is mounted to a cross rib 19 at the underside of the trough of conveyor module 3. The distal end of the cylinder rod 17 is resiliently connected to a rib member 25 mounted on the bottom of the slide gate plate 18 by means of a clevis or similar attachment. An opening 40 is cut into the bottom of the trough of conveyor 3, which is covered by a gate plate 18 when the cylinder rod 17 is extended. The gate plate 18 is held upward in close approximation to the bottom of the trough of conveyor 3 by means of spring-loaded adjustment clamps 20 attached to the gate guide bars 21. The gate guide bars 21 are used to maintain alignment of the gate as it moves and to prevent material from leaking out between the trough and gate plate 18 when the cylinder rod 17 is extended. When the cylinder rod 17 is retracted, the gate plate 18 is retracted, allowing product material to flow through the opening 40 cut into the bottom of the trough of conveyor 3, and into the transition funnel section 12. When the gate plate 18 is extended, product material is allowed to flow into the inlet end of the trough of conveyor 4. Also shown in FIG. 3 is part of the slide gate 16 having mounting bracket 27 fastened to the bottom of the trough of conveyor 4, to secure one end of a pneumatically operated cylinder 28.

FIG. 4 is a bottom view of the prior art pneumatic operated slide discharge gate of FIG. 3 showing some details on the construction and operation of gate 2. The mounting bracket 23 is fastened to the bottom of the trough of conveyor 3 to secure one end of a pneumatically operated cylinder 22 and its cylinder rod 17. The other end of the pneumatically operated cylinder 22 is mounted to a cross rib 19 on the trough of conveyor 3. The end of the cylinder rod 17 is resiliently connected to a rib member 25 mounted on the bottom of the slide gate plate 18 by means of a clevis. An opening 40 (shown in dotted lines) is cut into the bottom of the trough of conveyor 3, which is covered by the gate plate 18 when the cylinder rod 17 is extended as shown. The leading edge 29 of the opening 40 is also referenced. The gate plate 18 is held in close proximity to the bottom of the trough of conveyor 3 by means of spring-loaded adjustment clamps 20 attached to the gate guide bars 21, which are used to maintain alignment of the gate as it moves and to prevent material from leaking out between the trough and gate plate 18 when the cylinder rod 17 is extended. When the cylinder rod 17 is retracted, the gate plate 18 is retracted, allowing product material to flow through the opening 40 cut into the bottom of the trough of conveyor 3. Also included in the figure are the ends of the pneumatic fluid supply lines 39 and 41, usually clean compressed air, attached to the pneumatically operated cylinder 22.

As noted above, the foregoing construction of existing modular conveyor distribution systems have limitations and disadvantages. For example, gates, such as 2 and 16, are high-cost items as can be appreciated from the relative complexity of their design as illustrated in FIGS. 3 and 4. Not only does this directly affect margins and selling price, but also is a source of maintenance irritation for the customer. Referring to FIG. 4, for example, product material being fed in the conveyors 3, 4, and 5 is often quite friable and subject to easily being damaged between the gate plate 18 and the lip 29 of the opening 40 when the slide gate 2 closes, causing breakage and powdering of the product material. This not only impacts the quality of the packaged product, but also the damaged material accumulates and can find its way between the guide rails 21 and the gate plate 18, or between the gate plate 18 and the bottom of the trough of conveyor 3. This creates potential sanitary, wear and jamming problems, requiring the gates 2 and 16 to be dismantled and cleaned on a regular basis, reducing productivity of the system.

### SUMMARY OF THE INVENTION

The present invention is directed to a conveyor distribution system for receiving work product and then transferring the work product to a number of different locations. The system includes a first conveyor for receiving a work product and discharging the work product on to a second conveyor disposed at an elevation below the discharge location of the first conveyor. In the distribution system, the work product may be moved along the second conveyor to discharge the work product from the second conveyor. Also, the second conveyor may be operable to move the work product in a direction away from the distal discharge location of the second conveyor and toward the work product receiving location of the second conveyor to thereby discharge the work product from the receiving location of the second conveyor.

In a further aspect of the present invention, the first conveyor is of longitudinal construction and has a distal end portion corresponding to the work product discharge location of the conveyor. In addition, the second conveyor may also be of longitudinal construction, having a proximal end portion corresponding to the work product receiving location of the conveyor, and a distal end portion corresponding to the work product discharge location of the conveyor. The distal end portion of the first conveyor is disposed at an elevation above a proximal end portion of the second conveyor.

In a further aspect of the present invention, the first conveyor includes a longitudinal pan, having a pan distal end portion and a pan floor, and a second conveyor having a longitudinal pan, the second pan having proximal and distal end portions and a pan floor. The pan floor at the distal end portion of the first pan is disposed at an elevation above the pan floor at the proximal end portion of the second pan.

In a further aspect of the present invention, the distal end portion of the first pan is nested with the proximal end portion of the second pan to define a discharge gap between the pans, through which work product is discharged when the second conveyor is operated to discharge work product from the work product receiving location of the second conveyor.

In accordance with a further aspect, the present invention includes a third conveyor having a third longitudinal pan, the third pan having a proximal end portion, distal end portion, and a pan floor. The pan floor of the distal end portion of the second conveyor is disposed at an elevation above the pan floor of the proximal end portion of the third conveyor. The third conveyor may be operated to discharge the work product from either the work product discharge location at the distal end portion of the third conveyor or the work product receiving location at the proximal end portion of the third conveyor.

In accordance with a further aspect, the present invention includes a control system to control the operation of the first, second and third conveyors to load the second and third conveyors with work product and to operate the first, second, and third conveyors to discharge work product from the proximal or distal end portions of the second and third pans, as required by the conveyor distribution system.

### BRIEF DESCRIPTION OF THE DRAWINGS

The foregoing aspects and many of the attendant advantages of the present invention will become more readily appreciated as the same become better understood by reference to the following detailed description, when taken in conjunction with the accompanying drawings, wherein:

FIG. 1 is a side elevational, schematic view of a prior art modular conveyor distribution system showing three combinatorial weighing and packaging machines;

FIG. 2 is a top view of FIG. 1;

FIG. 3 is a side elevational view of a detail of a typical prior art pneumatic operated slide discharge gate;

FIG. 4 is a bottom view of FIG. 3;

FIG. 5 is a side elevational, schematic view of the modular conveyor distribution system of the present invention showing three combined weighing and packaging machines;

FIG. 6 is a fragmentary perspective side view of the transition between the discharge of one conveyor and the inlet of the next conveyor of the system of FIG. 5;

FIG. 6A is a fragmentary perspective view of the second and third conveyors shown in FIG. 5, but with the conveyors having floor-engaging base structures;

FIG. 6B is an enlarged fragmentary perspective view of the transition between the discharge location of the second conveyor and the receiving location of the third conveyor shown in FIG. 6A;

FIG. 7 is a top schematic view of FIG. 5;

FIG. 8 is a top schematic view of an alternative embodiment of the invention whereby the transverse discharge feeders, shown in FIGS. 5 and 7, are eliminated; and

FIG. 9 is a table showing the equipment status during operation of the present invention.

### DETAILED DESCRIPTION OF THE PREFERRED EMBODIMENT

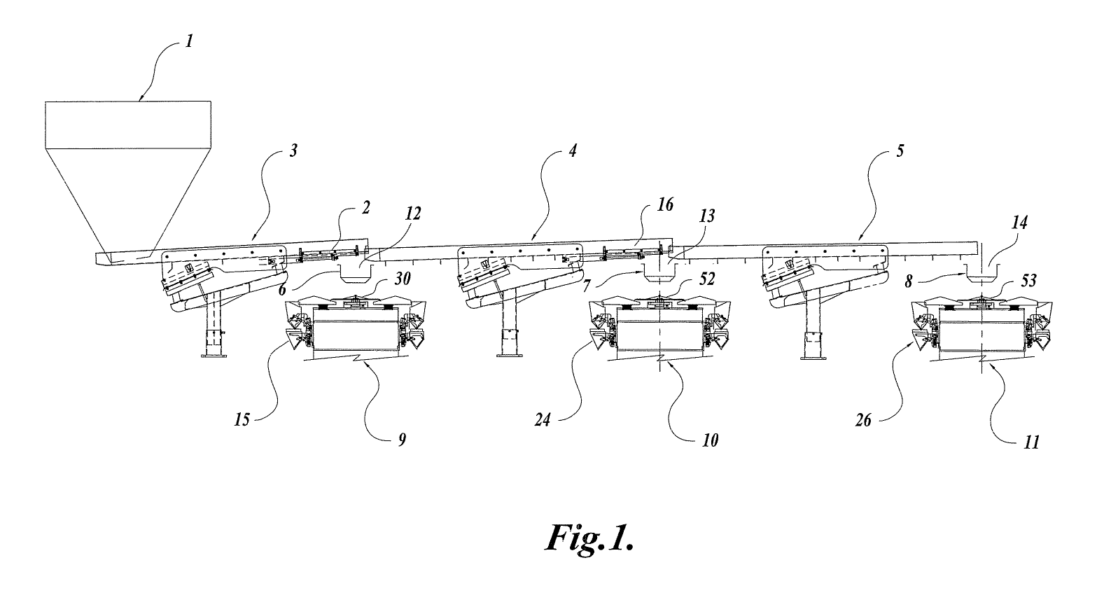

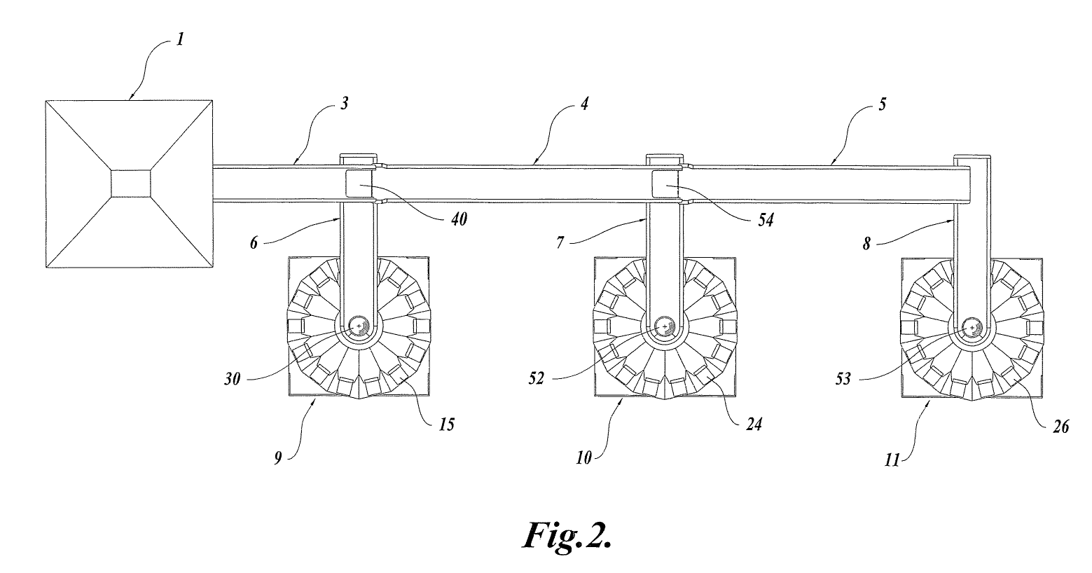

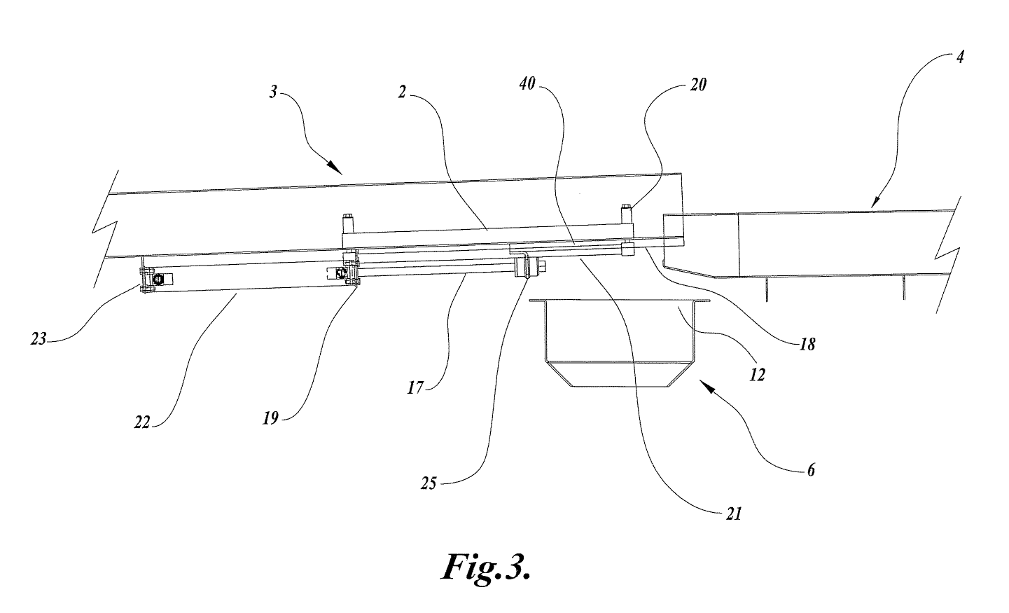

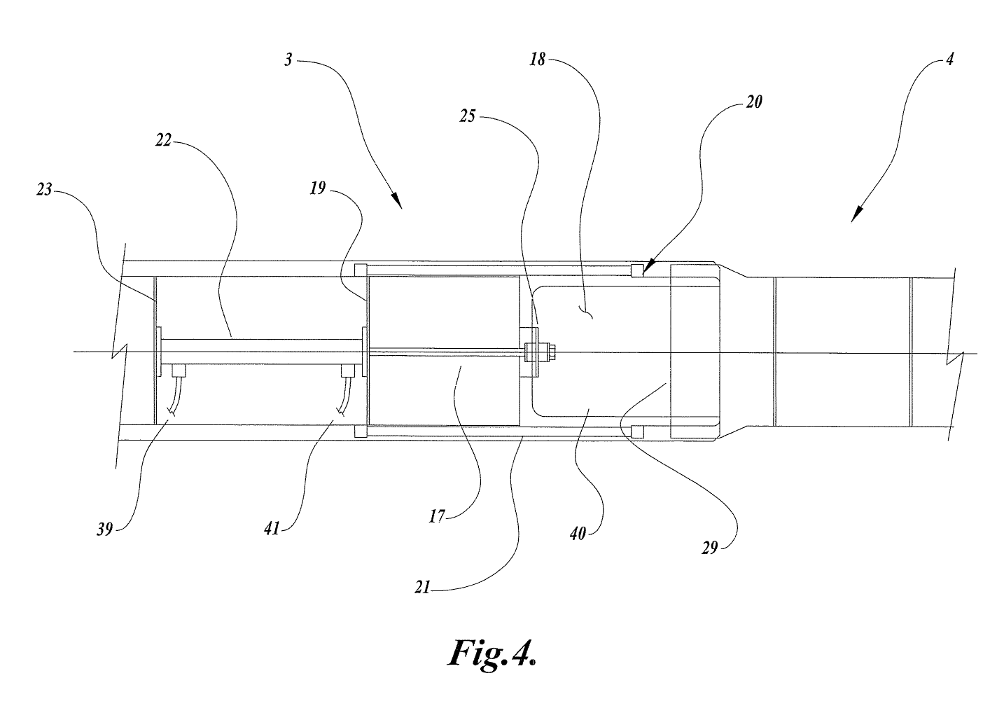

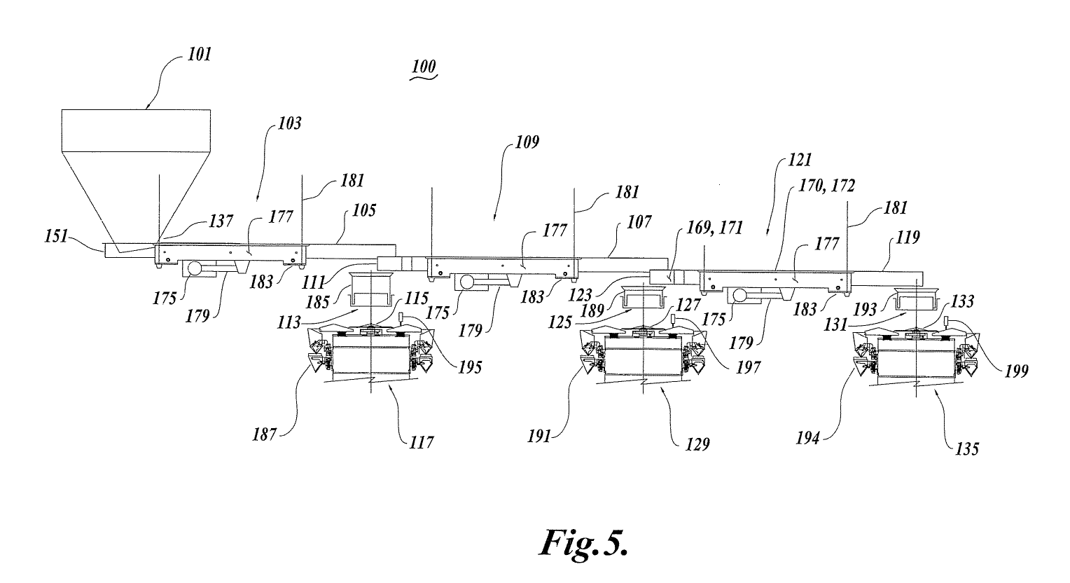

FIGS. 5, 6, 6A, 6B, and 7 illustrate one embodiment of modular conveyor distribution system 100 in accordance with the present invention. The conveyor distribution system 100 includes certain components that may be the same or similar to those components shown in FIGS. 1-4, in which case such same or similar components may be identified but not described in detail, so as not to be duplicative.

To initially provide a brief synopsis, the conveyor distribution system 100 of FIGS. 5-7 includes a supply hopper 101 to receive food or other work product to be distributed for packaging, further processing, or for other purpose. The conveyor distribution system 100 also includes a first distribution conveyor module 103 having an elongated pan 105, with the inlet end or location of the pan in registry with the outlet of hopper 101. The outlet end or location of the pan 105 may be nested with the inlet end of a pan 107 of a second or downstream modular distribution conveyor 109. The floor of the discharge end of the first pan is at an elevation above the floor of the inlet end or location of the second pan, so as to define a discharge gap 111 therebetween. This gap is in registry with a first transverse feed conveyor 113, which directs the work product from the gap 111 to a cone-shaped inlet receiver 115 of a combination weighing/packaging machine 117, used to package the work product in desired weights, volumes, or other quantities.

Still referring to FIGS. 5-7, the discharge end or location of the second pan 107 may be nested with the inlet end or location of the pan 119 of a third distribution conveyor module 121. The floor of the second pan 107 is at an elevation above the floor of the third pan 119 to define a discharge gap 123 therebetween. The discharge gap 123 is in registry with a second transverse feed conveyor 125, which delivers the work product to a cone-shaped inlet receiver 127 of a second combination weighing/packaging machine 129, which also packages the work product in desired weights, volumes, or other quantities.

The distal or discharge location of the third distribution conveyor module 121 is in registry with a third transverse feed conveyor 131, which in turn delivers the work product from the distal end or discharge location of the conveyor pan 119 to a cone-shaped inlet receiver 133 of a third weighing/packaging machine 135. As described below, the present invention supplies the work product to the packaging machines 117, 129, and 135, in an efficient manner, seeking to maximize the through-put of the work product.

Next, describing the present invention in more detail, the hopper 101 is schematically illustrated as configured to receive work product, including work products or cooking products, for temporary storage prior to distribution via the present invention. The work product may be transported to the hopper 101 by vibratory conveyors, by bulk containers which are dumped into the supply hopper, or other method. The hopper 101 has a bottom outlet 137 in registry over the proximal or inlet end of the first distribution conveyor module 103. A flow control or valving system, not shown, may be utilized to control and modulate the flow of the work product through the outlet 137.

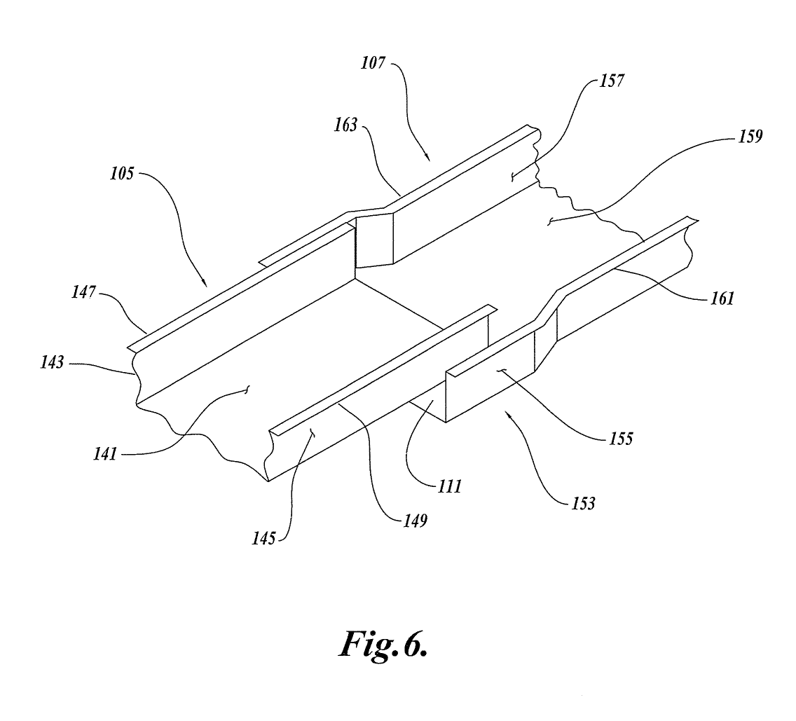

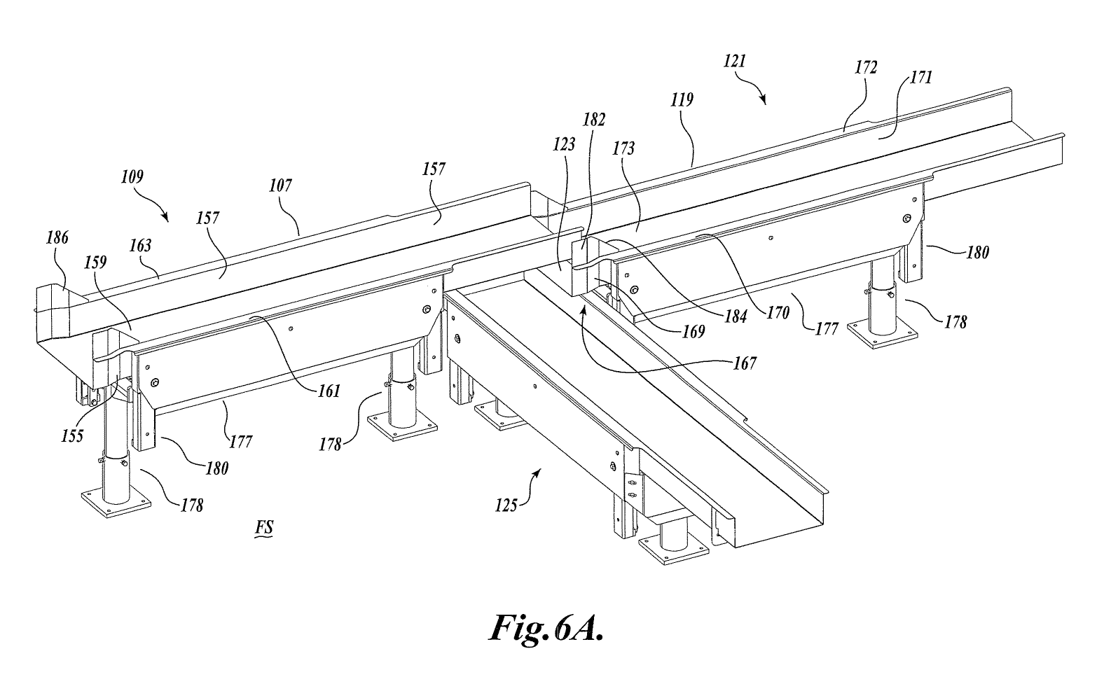

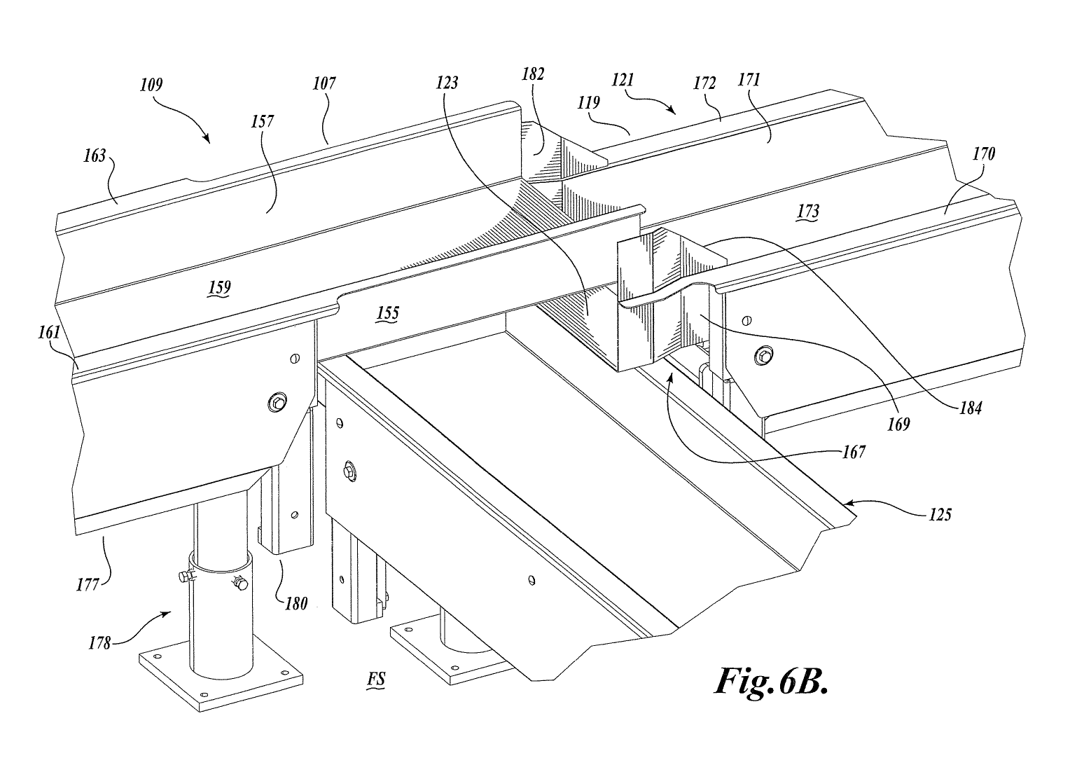

Next, the construction of the distribution conveyor modules 103, 109, and 121 will be described. Each of the distribution conveyors 103, 109, and 121 includes a longitudinal, trough-shaped pan 105, 107, and 119, respectively. FIG. 6 shows the second or distal end of pan 105 and the first or proximal end of pan 107. Pan 105 may be generally trough-like in shape, having a substantially flat floor or bottom 141 and upright side walls 143 and 145. A transverse flange 147 may extend generally horizontally outwardly from the upper edge of side wall 143, and correspondingly, a top flange 149 may extend laterally outwardly from the upper edge portion of pan sidewall 145. The first or proximal end of pan 105 is preferably closed off, for instance, by an end wall 151. The opposite distal or second end portion of the pan 105 is open, as shown in FIG. 6. Such open end portion of the pan 105 is nested with the adjacent first or proximal end portion 153 of pan 107. At first end portion 153, the side walls 155 and 157 of pan 107 may be disposed parallel to and slightly outwardly of the side walls 145 and 143 of pan 105 to accommodate the nesting arrangement between the distal end of pan 105 and the proximal end 153 of pan 107. As in pan 105, pan 107 also may include a flat floor or bottom 159 extending between the side walls 155 and 157. Distal or downstream to pan proximal end portion 155, the pan 107 is somewhat narrower in width, generally corresponding to the width of pan 105, but could be of other widths so as to influence the rate of flow of work product along the second distribution conveyor module 109, as well as the volume of work product that can be carried by the conveyor module. The side walls 155 and 157 include diagonal transition portions between a pan proximal end portion 153 and the remainder of the pan 107. As in pan 105, pan 107 may include transverse flanges 161 and 163, extending transversely outwardly from the upper edge portion of side walls 155 and 157. As shown in FIGS. 5 and 6, the elevation of floor 141 of pan 105 is somewhat above the elevation of floor 159 of pan 107, thereby to define an opening or gap 111 at the forward end of pan 107. As discussed below, work product is discharged from conveyor distribution system 100 through this gap.

Referring specifically to FIGS. 5, 6A, 6B, and 7, the distal end portion of second pan 107 may nest with the proximal end portion 167 of pan 119 in a manner very similar to the nesting of the distal end portion of pan 105 with the proximal end portion 153 of pan 107. As in pan proximal end portion 153, the pan proximal end portion 167 is widened relative to the remainder of the width of pan 119 to accommodate the width of the distal end portion of pan 107. As discussed more fully below, by this relationship, the pans 107 and 119 are capable of longitudinal relative lengthwise motion. Thus, the side walls 169 and 171 of pan 119 are separated from each other a greater distance at proximal end 167 than along the remainder of the pan 119. Diagonal wall sections provide the transition between the side walls 169 and 171 located at proximal end portion 167 and the remainder of the pan 119 in the same manner as the construction of pan 107. As in pan 107, the width of pan 119 can also be varied to change the flow capacity of the pan, as well as the volume capacity of the pan. Pan 119 may include transverse flanges 170 and 172 that extend transversely outwardly from the upper edge portion of sidewalls 169 and 171.

As in pans 105 and 107, pan 119 may include a flat bottom floor 173, which is positioned at an elevation below the elevation of the floor 159 of pan 107 to define an outlet opening or discharge gap 123. As discussed below, work product may be discharged from conveyor distribution system 100 through the gap 123, as well as from the open distal end of pan 119.

In the embodiment of the present invention shown in FIGS. 6A and 6B, side panels 182 extend upwardly from the side walls 169 and 171 of pan 119 at the proximal end 167 of the pan to an elevation corresponding to the elevation of the side walls 155 and 157 of the distal end portion of pan 107. In this manner, the side panels help keep the work product discharge from the distal end of conveyor module 109 from spilling sideways over the upper edge of the conveyor module 121, especially if the work product is piled up at this location. As shown in FIGS. 6A and 6B, the side panels 182 can be formed to conform to the shape of the corresponding portions of the side walls 169 and 171. The panels can have tapered distal upper edge portions 184 so as to transition from the upper edge portion of the panels down to the top flanges 170 and 172 of the side walls 169 and 171. Similar side panels 186 are positioned at the forward end of the second pan 107. In this manner, the side panels 186, functioning similarly to side panels 182, keep the work product discharged from the distal end portion of conveyor module 103 from spilling sideways over the upper edge of conveyor module 109, when, for example, the work product is piled up at this location. The side panels 186 in size and shape are the same or similar to side panels 182.

The distribution conveyor modules 103, 109, and 121 can be of various constructions. For example, such conveyors can be of a “differential motion” type. Differential motion conveyors typically employ primarily horizontal driving forces, unlike vibratory conveyors which typically include both horizontal and vertical conveying forces. For use in the present invention, the differential motion conveyors are capable of reversing their feed direction.

In one embodiment, the modular distribution conveyors 103, 109, and 121 of the present invention may include differential motion conveyors available from the Allen Systems Division of FMC Technologies, Incorporated. Such differential motion conveyors may include servomotor 175 mounted on a base or frame structure 177, which supports pans 105, 101, and 119 for longitudinal movement. The servomotor 175 is connected to a pan 105, 107, 119 through a drive arm 179, which is reciprocated by the servomotor 175. The servomotor 175 is operable to move the pan 105, 107, 119 in a first direction at a lower velocity through the stroke length of the servomotor, and then return to the starting position of the drive arm at a second, higher velocity, to complete a drive cycle. Work product on the pan 105, 107, 119 moves with the pan, or substantially with the pan, during the lower velocity portion of the drive cycle, and then slides or slips on the pan during the high velocity return portion of the cycle. As such, there is a net movement of the work product in the direction of the lower velocity portion of the drive cycle.

From the same initial pan starting position, reversing the velocity pattern generated by the servomotor to a first, higher velocity followed by a lower, return velocity reverses the feed direction of the conveyor distribution modules 103, 109, 121 without reversing the direction of rotation of the servomotor. As such, it is possible to quickly change the feed direction of the conveyor module. Such differential motion conveyors from the Allen Systems Division of FMC Technologies are disclosed in co-pending U.S. Provisional Patent Application No. 60/637,430, incorporated herein by reference.

Referring specifically to FIG. 5, conveyor module frames 177 are illustrated as being supported by suspension lines 181 extending downwardly from overhead locations, to be pivotally attached to the upper locations on frame members 183. In this manner, the frames 177 are allowed to displace longitudinally in the direction opposite the movement of the corresponding conveyor pans 105, 107, and 114. This movement of the frames 177 helps counteract the horizontal forces generated during the operation of the conveyor modules. The longitudinal displacement of the frames 177 is sufficiently small so as to result in very little elevational change of the frames during such movement.

FIGS. 6A and 6B illustrate the conveyor module frames 177 as supported by pedestal structures 178 that extend downwardly from the module frames 177 to support the conveyor modules on the underlying floor surface (FS). As described in U.S. Provisional Application No. 60/637,430, swing arm assemblies 180 are interposed between the frames 177 and the support pedestals 178 to enable the frames 177 to displace longitudinally in the direction opposite movement of the corresponding conveyor pans 105, 107, and 119. As noted above, the movement of the frames 177 helps counteract horizontal forces generated during the operation of the conveyor modules. Also, the longitudinal displacement of the frames 177 are sufficiently small so as to result in very little elevational change of the frames during such movement.

As shown in the figures, the gap 111 defined by the distal end of pan 105 and the proximal end of pan 107 is in registry with a funnel section 185 to receive the work product from the gap and guide the work product onto a receiving end of the first transverse feed conveyor 113. Such funnel section and feed assembly may correspond to funnel section 12 and feed assembly 6 described above. Such components are well known in the art. The transverse feed conveyor 113 transports the work product to a cone-shaped inlet receiver 115 of the combined weighing/packaging machine 117. Such combined weighing/packaging machine includes a weigh bucket 187 for receiving the work product. Packaging machine 117, as well as packaging machines 129 and 135, utilize a bag-forming apparatus that forms bags from plastic, foil film, or other materials. The work product is fed into the formed bags and then the bags are sealed and discharged. Other operations, such as date stamping and applying serial numbers, may also be performed at the bagging operation. Combined weighing and packaging machines, such as machines 117, 129, and 135, are well known in the art.

A second transition funnel section 189 is positioned at the discharge gap 123, defined by the distal end of conveyor pan 107 and the proximal end of conveyor pan 119. The funnel section 189 may function in the same manner as funnel section 185 to direct work product to a transverse feed conveyor 125, which is operationally and structurally similar to transverse feed conveyor 113. The feed conveyor 125 directs work product to the cone-shaped inlet receiver 127, which is similar to receiver 115. The inlet receiver 127 is associated with a second combined weighing/packaging machine 129, which is the same or similar to combined weighing/packaging machine 117, described above. The combined weighing/packaging machine 129 also includes weigh buckets 191 similar to weigh buckets 187.

The distal end of conveyor pan 119 is in registry with a transition funnel section 193, which is similar to corresponding funnel sections 185 and 189. The funnel section 193 functions similarly to funnel sections 185 and 189 to direct work product discharged from the distal end of the conveyor module 121 to the inlet end of transverse feed conveyor 131, which in turn transfers the work product to the cone-shaped inlet receiver 133 associated with combined weighing/packaging machine 135. The weighing/packaging machine 135 is structurally and functionally similar or essentially the same as weighing/packaging machines 117 and 129. In this regard, the weighing/packaging machine 135 includes weigh buckets 194.

The present invention utilizes various sensors to sense the level of work product at various locations along the conveyor distribution system 100. In this regard, work product level/weight sensor/controllers 195, 197, and 199 are associated with the cone-shaped inlet receivers 115, 127, and 133 of the combined weighing/packaging machines 117, 129, and 135. The product level/weight controllers 195, 197, and 199 may be adjusted to send a signal to a desired location when the work product reaches a certain volume/weight or level within the receivers. Sensors 201, 202, and 203 may also be positioned in the conveyor pans 107 and 119 to sense the level of the work product within such conveyor pans. Although the sensors are located toward the end portions of these conveyors, the sensors can be positioned at other locations along the pans. Also, additional sensors may be positioned along the pans in addition to sensors 201, 202, and 203.

In addition, level sensors 205, 207, and 209 may be positioned at the proximal end portions of transverse feed conveyors 113, 125, and 131 or at other locations along such conveyors to sense the level of work product within the transverse feeder. These sensors, as well as sensors 201 and 203, can be programmed to transmit a signal or signals to desired locations when the level of work product within the transverse feeders rises to a particular level and/or lowers to a particular level. Typically, but not necessarily exclusively, the sensors control the operation of a component immediately upstream from the location of the sensor in question. This can result in a less complicated control logic than if a sensor were to control functions significantly removed from the location of the sensor.

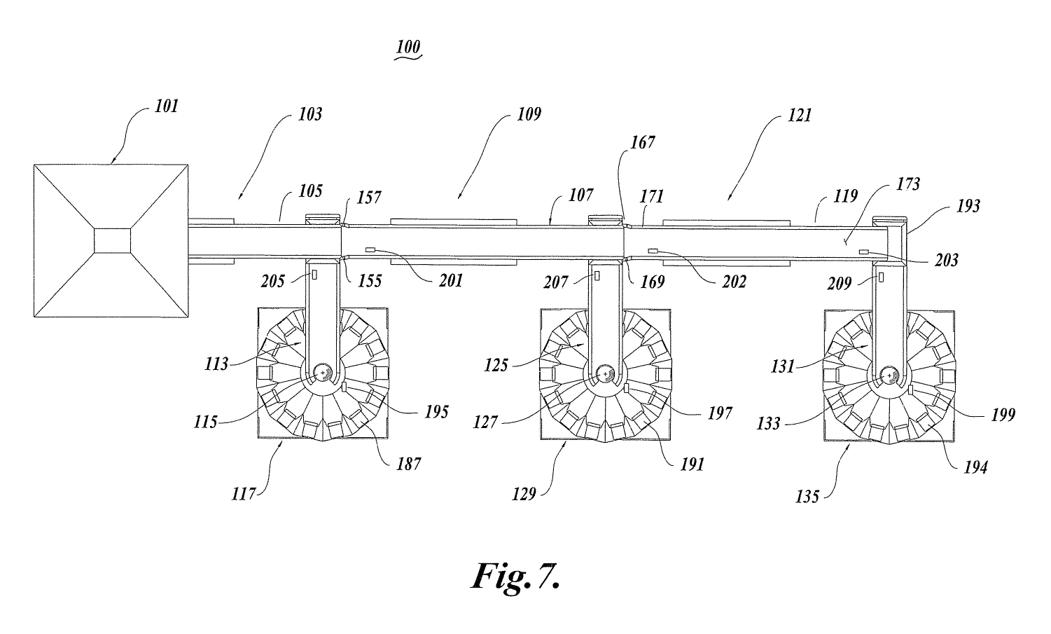

In the operation of the present invention, work product from hopper 101 is nominally advanced along conveyor modules 103, 109, and 121 from left to right, as viewed in FIGS. 5 and 7. When a work product feed demand signal is received from sensors 195, 197, or 199 at the combined weighing/packaging machines 117, 129, or 135, the associated transverse feed conveyors 113, 125, or 131 start in the forward or downstream direction, allowing the work product to be fed into the inlet cone member 115, 127, or 133. The work product is then transferred to the weigh buckets 187, 191, or 194 of the combined weighing/packaging machine 117, 129, or 135.

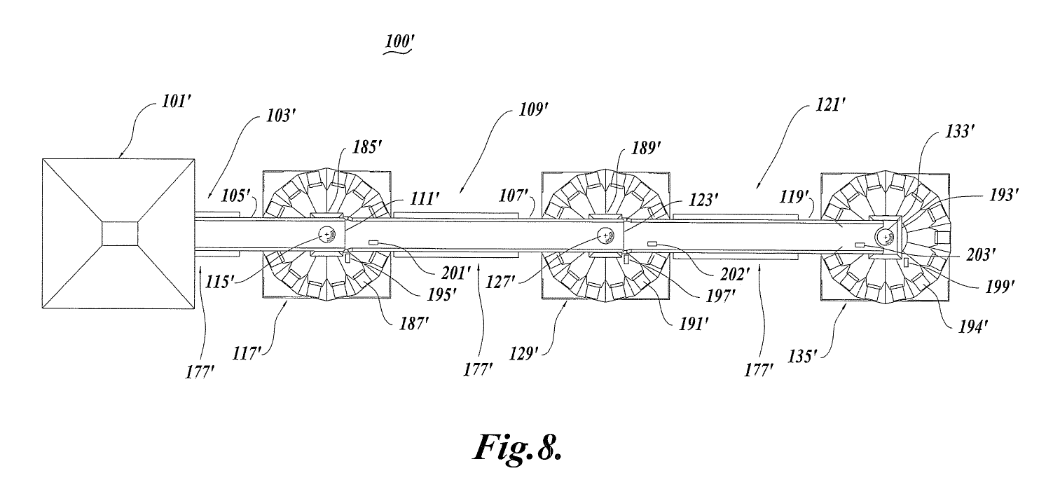

The movement of the work product on the transverse feed conveyors 113, 125, or 131 creates product “gaps” or voids at the beginning or proximal ends of the conveyors which are detected by sensors 205, 207, or 209, respectively. The priority of system response to the sensors is sensor 209, then sensor 207, and lastly, sensor 205. When sensor 209 detects a gap in the work product at the inlet to the transverse feed conveyor 131, the modular distribution conveyors 103, 109, and 121 are turned on in the forward direction to provide work product to the transverse feed conveyor 131. Once this need is met, the next sensor that prioritizes transverse feed is sensor 207. When sensor 207 detects a gap in the work product on transverse conveyor 125, distribution conveyors 103 and 109 are stopped, as long as sensor 202 detects work product, to prevent an excess height of work product at gap 123, and distribution conveyor 121 is run in the reverse direction, providing work product feed at the inlet of transverse feed conveyor 125. If distribution conveyor 121 runs for an appreciable length of time in the reverse direction, the leading edge of the product in said conveyor will eventually recede to a point upstream of sensor 202 (to the left of sensor 202 in FIGS. 7 and 8). This low-product signal will activate distribution conveyors 103 and 109 to run in the forward direction so as not to “starve” transverse feed conveyor 125.

Last in priority is transverse feed sensor 205. When this sensor detects a gap of work product on transverse feed conveyor 113, distribution conveyor 103 is stopped as long as detector 201 detects work product, to prevent an excess height of work product at gap 111, and distribution conveyor 109 is run in the reverse direction to provide work product to transverse feed conveyor 113. If distribution conveyor 109 runs for an appreciable length of time in the reverse direction, the leading edge of the product in said conveyor will eventually recede to a point upstream of sensor 201 (to the left of sensor 201 in FIGS. 7 and 8). This low work product signal will activate distribution conveyor 103 to run in the forward direction so as not to “starve” transverse feed conveyor 113.

If all of the transverse feed conveyors are satisfied as indicated by high level signals from sensors 205, 207, and 209, then control will be determined by the condition of sensor 203. A low work product signal by this sensor will activate distribution conveyors 103, 109, and 121 to run in the forward direction, thereby pulling product forward and eliminating gaps in the system. When sensor 203 detects work product, it will stop distribution conveyors 103, 109, and 121.

Alternatively, or additionally as noted above, sensors 201, 202, and 203 may be installed at other locations along conveyor troughs 107 and 119, thereby to monitor the level of work product in the pans. It is also realized that sensor 203 could be eliminated from the system shown in FIG. 7 and the “pull work product forward” function be performed by sensor 209. Alternately, additional “pull work product forward” sensors could be installed on distribution conveyors 103 and 109 to provide additional control of product movement.

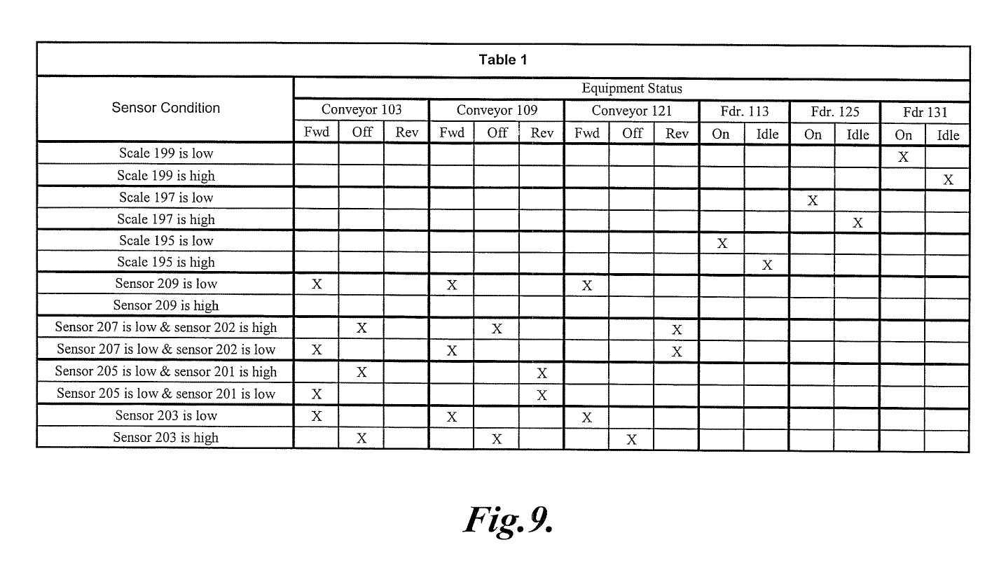

It can be appreciated that by the foregoing construction, the present invention can eliminate the need for conveyor gates, such as gates 2 and 16 shown in FIG. 1 and the attendant limitations and drawbacks of such gates, discussed above. The functions of the conveyor distribution system 100 of the present invention are preferably controlled by a programmable logic control system (PLC). The functions of the PLC systems are set forth in the table illustrated by FIG. 9.

FIG. 9 shows the possible states of the various sensors of the present invention and the resulting impact on the operation of distribution conveyor modules 103, 109, and 121. The “truth table” of FIG. 9 is arranged so that states at the top have a higher priority than those at the bottom. When the conveyor system 100 is initially started up, the scale sensors 195, 197, and 199 will be “low,” causing transverse feeders 113, 125, and 131 to run. Sensor 209 is initially low, causing distribution conveyors 103, 109, and 121 to run. Eventually, work product will reach this sensor. Sensor 209 is positioned high enough to sense a pile of work product, but not the normal running depth. Therefore, work product will flow to third inlet receiver 133 until sensor 199 is satisfied, at which time transverse conveyor 131 will cease to convey work product. Conveyor 121 will continue to run, creating a “pile” of work product at the proximal end of transverse conveyor 131. This will cause sensor 209 to “go high.” Since sensor 207 is calling for work product, distribution conveyor 121 will reverse its direction, and conveyors 103 and 109 will stop running. Work product will now be discharged through aperture 123 until sensor 197 is satisfied, at which time transverse conveyor 125 will cease to convey work product. This will cause sensor 207 to “go high.” Since sensor 205 is calling for work product, distribution conveyor 109 will reverse its direction. Work product will now be discharged through aperture 111 until sensor 195 is satisfied. Eventually, sensor 209 will call for work product, causing the modular conveyors to run forward again. If all scales 195, 197, and 199 and sensors 209, 207, and 205 are satisfied, product will move forwardly along modular conveyors 103, 109, and 121 until sensor 203 is satisfied, to keep the system 100 charged as full as possible.

This represents but one control method for system 100. The inventors recognize that other methods may be used. For instance, the upstream conveyors may continue to run while the downstream conveyor reverses. This may require taller and/or wider apertures, but otherwise will work fine. Also, the priority of the system may be set differently than stated. It may be reversed so that that the upstream scales have priority over the downstream scales. Or, it may be preferred to have the middle scale as the highest priority, rather than one of the end ones. This may be due to different scale capacities along the line.

As can be appreciated, the PLC system provides the applicable control logic to resolve conflicting demand signals from sensors 205, 207, and 209 or from sensors 195, 197, and 198 to give priority to the desired sensor. The PLC system also provides the required logic to shut down the conveyor distribution system 100 in an orderly manner so that the conveyor modules 103, 109, and 121, as well as the transverse feeders 113, 125, and 131, are emptied of the work product. The foregoing status or condition of the components of the conveyor distribution system 100 of the present invention is set forth in the table of FIG. 9.

FIG. 8 is a top elevational view of another conveyor distribution system 100′ of the present invention using many of the same or similar components as conveyor distribution system 101. As such, the components of conveyor distribution system 101′ that are the same or similar to the components of conveyor distributor systems 101 are designated with the same part number, but with the addition of a prime (′) designation. To this end, a conveyor distributor system 100′ includes the transverse discharge feeders 113′, 125′, and 131′ of FIGS. 5 and 7 are eliminated by positioning the conveyor modules 103′, 109′, and 121′ directly over the central portion of combined weighing/packaging machines 117′, 129′, and 135′. As such, a gap 111′ defined by conveyor pans 105′ and 107′ is positioned over transition funnel section 185′ which in turn guides the work product directly onto a cone-shaped inlet receiver 115′ of a combined weighing/packaging machine 117′.

Correspondingly, a gap 123′ defined by the distal end of conveyor pan 107′ and the proximal end of a conveyor pan 119′, is positioned over transition funnel section 189′ to guide the work product onto a cone-shaped inlet receiver 127′ of the combined weighing/packaging machine 129′. Correspondingly, the distal or discharge end of the third conveyor module 121′ is positioned over the transition funnel section 193′ to guide the work product onto the cone-shaped inlet receiver 133′ of the combined weighing/packaging machine 135′.

The conveyor discharge system 101′ shown in FIG. 8 operates similarly to the conveyor discharge system 100 shown in FIGS. 5-7, except without the use of sensors 205, 207, and 209. Rather, “demand” signals for work product for the combined weighing/packaging machines 117′, 129′, and 135′ are received through sensors 195′, 197′, and 199′. In all other respects, the conveyor distribution system 100′ may operate the same as, and may be controlled by, a PLC system in the same manner as conveyor distribution system 100′.

While specific embodiments of the present invention have been illustrated and described, it will be appreciated that various changes can be made therein without departing from the spirit or scope of the present invention. For example, the distributed conveyor modules 103, 109, and 121 can be of a different construction and operate differently than described above. In this regard, the distal end portions of the conveyors need not be nested with the proximal end portion of the next “downstream” conveyor, rather the pan of the upstream conveyor can actually be at an elevation above the proximal end of the next downstream conveyor to define a discharge gap between the pan floors of a height greater than the depth of the pan of the downstream conveyor.

Also, the embodiments of the present invention illustrated above utilize three conveyors in sequence. The present invention can be utilized with different numbers of distribution conveyor modules. For example, the present invention can utilize two conveyor modules, three conveyor modules, four conveyor modules, five conveyor modules, etc. Also, the transverse feed conveyors can be designed to operate in both longitudinal directions. As such, it is possible for the transverse feed conveyors to be used with combined weighing/packaging machines located at both end portions of the transverse feed conveyor.

Moreover, other types of sensors can be used to replace sensors 195, 197, 199, 201, 203, 205, 207, and/or 209. Further, such sensors may be positioned in other locations than specified above, and additional sensors could be utilized, for example, additional sensors along the length of a conveyor pan.

The invention is claimed as follows:

1. A conveyor distribution system for receiving work product and transferring the work product to a plurality of locations, comprising:
(a) a first conveyor for receiving work product, the first conveyor having a work product discharge location;
(b) a second conveyor having a work product receiving location for receiving work product from the first conveyor, and also having a work product discharge location spaced from the work product receiving portion;
(c) wherein the work product receiving location of the second conveyor being at an elevation below the work product discharge location of the first conveyor; and
(d) wherein the conveyor distribution system being operable to move the work product along the second conveyor in a direction to discharge the work product from the work product discharge location of the second conveyor and also being operable to move the work product in a direction away from the discharge location of the second conveyor toward the work product receiving location of the second conveyor to discharge the work product from the work product receiving location of the second conveyor.

2. The conveyor distribution system according to claim 1, further comprising a control system to control the operation of the first and second conveyors, to load the second conveyor with work product and to operate the second conveyor to discharge the work product from either the work product receiving location or the work product discharge location of the second conveyor as required by the conveyor distribution system.

3. The conveyor distribution system according to claim 1, wherein:
(a) the first conveyor being of longitudinal construction and having a distal end portion corresponding to the work product discharge location;
(b) the second conveyor being of longitudinal construction and having a proximal end portion corresponding to the work product receiving location and a distal end portion corresponding to the work product discharge location; and
(c) the distal end portion of the first conveyor disposed at an elevation above the proximal end portion of the second conveyor.

4. The conveyor distribution system according to claim 3, wherein:
(a) the first conveyor having longitudinal pan, said pan having a distal end portion and a pan floor;
(b) the second conveyor having a second longitudinal pan, said second pan having proximal and distal end portions and a pan floor; and
(c) the pan floor of the distal end portion of the first pan disposed at an elevation above the pan floor of the proximal end portion of the second pan.

5. The conveyor distribution system according to claim 4, wherein the distal end portion of the first pan is nested with the proximal end portion of the second pan to define a discharge gap between the pans through which work product is discharged when the second conveyor is operated to discharge work product from the work product receiving location of the second conveyor.

6. The conveyor distribution system according to claim 4, further comprising:
a third conveyor having a third longitudinal pan, said third pan having a proximal end portion, a distal end portion, and a pan floor; and
wherein the pan floor at the distal end portion of the second conveyor is disposed at an elevation above the pan floor of the proximal end portion of the third pan.

7. The conveyor distribution system according to claim 6, wherein:
the distal end portion of the first conveyor pan is nested with the proximal end portion of the second conveyor pan to define a discharge gap between the first and second pans; and
the distal end portion of the second conveyor pan is nested with the proximal end portion of the third conveyor pan to define a discharge gap between the second and third pans.

8. The conveyor distribution system according to claim 6, further comprising a control system to control the operation of the first, second and third conveyors to load the second and third conveyors with work product and to operate the first, second and third conveyors to discharge work product from the proximal or distal end portions of the second and third pans as required by the conveyor distribution system.

9. The conveyor distribution system according to claim 1, further comprising a third conveyor having a work product receiving location disposed for receiving work product from the work product discharge location of the second conveyor, the third conveyor also having a work product discharge location spaced from the work product receiving location of the third conveyor, the third conveyor being operable to move work product received from the second conveyor in a direction to discharge the work product from the work product discharge location of the third conveyor and also operable to move the work product in a direction away from the discharge location of the third conveyor to discharge the work product from the work product receiving location of the third conveyor.

10. The conveyor distribution system according to claim 9, further comprising a control system to control the operation of the first, second, and third conveyors to load the second and third conveyors with work product and to operate the first, second and third conveyors to discharge work product from the work product receiving locations or the work product discharge locations of the second and third conveyors as required by the conveyor distribution system.

11. The conveyor distribution system according to claim 9, wherein the third conveyor is a differential motion conveyor capable of moving toward the work product discharge location or moving in the opposite direction toward the work product receiving location at different speeds.

12. The conveyor distribution system according to claim 11, wherein the second conveyor is a differential motion conveyor capable of moving toward the work product discharge location or moving in the opposite direction toward the work product receiving location at different speeds.

13. The conveyor distribution system according to claim 1, wherein the second conveyor is a differential motion conveyor capable of moving in a first direction toward the work product discharge location of the second conveyor or moving in the opposite direction toward the work product receiving location of the second conveyor at different speeds.

14. The conveyor distribution system according to claim 1, further comprising a frame for supporting the second conveyor for movement of the second conveyor in a first direction toward the work product discharge location of the second conveyor and also in the opposite direction toward the work product receiving location of the second conveyor.

15. The conveyor distribution system according to claim 14, further comprising the suspension system to suspend the second conveyor from the conveyor frame system so that the second conveyor and its corresponding frame are capable of moving in opposite, relative directions, thereby to offset the dynamic forces generated by the movement of the conveyor.

16. A conveyor distribution system for receiving work product and distributing the work product to a plurality of locations, comprising:
(a) a first conveyor for receiving a work product along the first conveyor in a downstream direction, the first conveyor having a distal downstream end portion; and
(b) a second conveyor having a proximal end portion disposed for receiving work product from the distal end portion of the first conveyor, and also having an opposite distal end portion, the second conveyor being operable to move the work product along the second conveyor in the downstream direction to discharge the work product from the distal end portion of the second conveyor and also operable to move the work product in the upstream direction to discharge the work product from the proximal end portion of the second conveyor.

17. The conveyor distribution system according to claim 16, further comprising a control system to control the operation of the first and second conveyors, to load the second conveyor with work product and to operate the second conveyor to discharge the work product from either the proximal end portion or the distal end portion of the second conveyor as required by the conveyor distribution system.

18. The conveyor distribution system according to claim 17, further comprising a third conveyor having a proximal end portion disposed for receiving work product from the distal end portion of the second conveyor, the third conveyor also having an opposite distal end portion, the third conveyor being operable to move the work product in the downstream direction to discharge the work product from the distal end portion of the third conveyor and operable to move the work product in an upstream direction to discharge the work product from the proximal end portion of the third conveyor.

19. The conveyor distribution system according to claim 18, wherein either or both second and third conveyors are a differential motion conveyors capable of moving in the downstream and upstream directions at different speeds.

20. The conveyor distribution system according to claim 16, wherein the second conveyor is a differential motion conveyor capable of moving in the downstream and upstream directions at different speeds.

21. A conveyor distribution system for receiving work product and for transferring the work product to a plurality of locations, comprising:
(a) a first conveyor having a longitudinal pan for receiving the work product and a drive system for moving the work product in a downstream location along the pan, the first pan having a distal end portion;
(b) a second conveyor having a second longitudinal pan, the second longitudinal pan:
having a proximal end portion for receiving work product from the first pan and a distal end portion at the opposite end of the second pan, the proximal end portion of the second conveyor pan being at an elevation below the elevation of the distal end portion of the first conveyor pan; and
a drive system for moving work product along the second conveyor pan in both the downstream direction and the upstream direction as selected, whereby work product may be discharged from either the distal end portion of the second conveyor pan or the proximal end portion of the second conveyor pan as required by the conveyor distribution system.

22. The conveyor distribution system according to claim 21, wherein the distal end portion of the first pan is nested with the proximal end portion of the second pan to define a discharge gap between the pans through which the work product is discharged when the second conveyor is operated to discharge work product from the proximal end portion of the second conveyor.

23. The conveyor distribution system according to claim 21, further comprising a third conveyor having a third longitudinal pan, the third longitudinal pan:
having a proximal end portion for receiving work product from the distal end portion of the second pan, and a distal end portion at the opposite end of the third pan, the proximal end portion of the third conveyor pan being at an elevation below the elevation of the distal end portion of the second conveyor pan; and,
a drive system for moving the work product along the third conveyor pan in both the upstream and downstream directions as selected, whereby work product may be discharged from either the distal end portion of the third conveyor pan or the proximal end portion of the third conveyor pan as required by the conveyor distribution system.

24. The conveyor system according to claim 23, wherein the distal end portion of the second conveyor pan is nested with the proximal end portion of the third conveyor pan to define the discharge gap between the pans to discharge the work product when the third conveyor is operable to move work product in the upstream direction.
